(19) United States
(12) Patent Application Publication
(10) Pub. No.: US 2026/0222288 A1
(43) Pub. Date: Jul. 30, 2026

(54) Delayed Onboarding for Late Attachment of Management Systems

(71) Applicant: Dell Products L.P., Round Rock, TX (US)

(72) Inventors: Bradley K. Goodman, Nashua, NH (US); Curtis J. Schwebke, Round Rock, TX (US); Jacob Hutcheson, Pflugerville, TX (US); Christopher Atkinson, Woodstock, GA (US)

(73) Assignee: Dell Products L.P., Round Rock, TX (US)

(21) Appl. No.: 19/041,931

(22) Filed: Jan. 30, 2025

(51) Int. Cl. H04L 41/0806

(52) U.S. Cl. CPC H04L 41/0806

(57) ABSTRACT

Systems and methods for delayed onboarding of information handling systems (IHS) to management systems are disclosed. The approach addresses the challenge of securely onboarding generic devices or white-box systems to a control plane without prior configuration. Embodiments comprise an out-of-band processor, such as a Baseboard Management Controller (BMC), executing an onboarding client that continuously attempts to connect to an onboarding service. This process allows devices to be attached to control planes in a zero-touch, secure manner, even after initial setup and operation of in-band components of the device.

### BACKGROUND

As the value and use of information continues to increase, individuals and businesses seek additional ways to process and store information. One option is an Information Handling System (IHS). An IHS generally processes, compiles, stores, or communicates information or data for business, personal, or other purposes. Technology and information handling needs and requirements can vary between different applications. Thus, IHSs can also vary regarding what information is handled, how the information is handled, how much information is processed, stored, or communicated, and how quickly and efficiently the information can be processed, stored, or communicated. The variations in IHSs allow systems to be general or configured for a specific user or specific use such as financial transaction processing, airline reservations, enterprise data storage, internet of things (IOT) monitoring and communications, or global communications. In addition, IHSs can include a variety of hardware and software resources that can be configured to process, store, and communicate information and can include one or more computer systems, graphics interface systems, data storage systems, and networking systems. IHSs can also implement various virtualized architectures. Data communications among information handling systems may be via networks that are wired, wireless, optical or some combination.

IHSs can be used in a distributed environment as edge devices. Example edge devices include applications running in a retail store, such as point of sale device, a gateway, a compute or storage device not operating in a datacenter, remote industrial sensor and monitoring equipment, or deployed telecommunications equipment. The edge devices may require management by a central orchestrator.

### SUMMARY

Embodiments are directed to a zero-touch, secure onboarding method on an out-of-band processor for the purpose of setting up and managing a system that could otherwise be running software or an operating system with no knowledge or ability to securely onboard. A generic device or white-box system can perpetually attempt to run a control-plane onboarding process on an out-of-band system in parallel to other applications operating on the normal in-band plane. A device may operate with no onboarding or no control plane and then later allowed onboarding unto new management or a new control plane. The device may continue to run an onboarding process even after onboarding in attempt to assess possible changes of configuration or ownership, automatically.

### BRIEF DESCRIPTION OF THE DRAWINGS

Having thus described the invention in general terms, reference will now be made to the accompanying drawings, which are not necessarily drawn to scale, and wherein:

FIG. 1 is a high level block diagram illustrating a process for onboarding a device at a customer location using an onboarding process.

FIG. 2 is a high level block diagram illustrating a generic device or white-box system connected to a control plane.

FIG. 3 shows an example of an Information Handling System configured to implement systems and methods as described herein for white-box systems and delayed onboarding for late attachment of management systems.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The Fast IDentity Online (FIDO) Alliance has promulgated a set of security-focused technologies and protocols intended to simplify and enhance cybersecurity. Information handling systems, such as server devices and/or other computing devices, may benefit by performing authentication via the FIDO Device Onboarding (FDO) protocol, particularly when provided at the “edge” of a network (“edge devices”). FDO is a system of zero-touch secure onboarding that is designed to have endpoint devices securely and automatically determine who their proper owner is, and then connect, onboard to, and be operated by said owner; without this being configured or even determined at manufacturing time.

Late Binding: FDO and similar systems of zero-touch, secure onboarding allow devices to be late-bound. This means the devices can be built with no knowledge of who a final owner will be or even the type of software or operating system that the device will run. Thus, a “generic” device can be built in manufacturing and then shipped to the customer or stocked in a warehouse for a future customer. After purchase and installation, the device's final, intended owner is determined. The final owner also decides what software should run on the device and how the device will be configured and credentialed so that it can be accessed and managed by the customer and/or upstream control systems. Zero-touch onboarding systems provide a means for all of this to happen automatically, meaning that onboarding can occur with “zero-touch” and without any user intervention. The onboarding is also secure, which allows onboarding to be stated and done in a provable manner. Zero-touch Secure onboarding allows the final disposition of a device to be both post-manufacture and in a strong, provable manner.

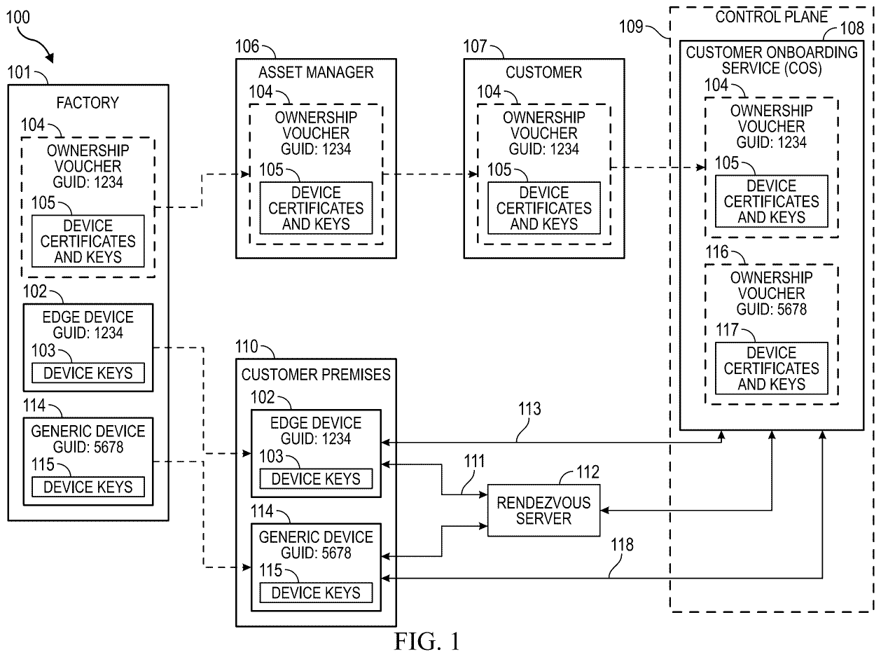

FIG. 1 is a high level block diagram illustrating a process 100 for onboarding a device at a customer location using FDO. A customer orders a device, such as an edge device or end point device, from a manufacturer. The customer provides the edge device requirements and optional details to the manufacturer. These requirements and details are passed on to the manufacturer's factory 101 for further processing. The factory 101 manufactures a device 102 with the customer requirements. During manufacture, the factory 101 executes a FIDO Device Initialization (DI) process and adds various keys 103 to the device 102. The keys 103 may include, for example, a device attestation key, a manufacturing key, and a secret key. Factory 101 also generates an ownership voucher 104, which may include certain keys and certificates 105, such as a device certificate. The device 102 has a Globally Unique Identifier (GUID) that can be used to identify a particular item. The ownership voucher 104 can be linked to the device 102 using the GUID.

The ownership voucher 104 makes multiple ownership hops as per the FIDO protocol as it is transferred to the final user of device 101. For example, ownership voucher 104 may be initially transferred to an asset manager 106, which would authenticate the voucher using an asset manager manger certificate paired to an asset manager key on ownership voucher. Asset manager 106 may modify the ownership voucher 104 by adding a customer key. The ownership voucher 104 may then be transferred to a customer 107. The customer 107 authenticates ownership voucher 104 using a customer certificate paired to a customer key on the ownership voucher. Customer 107 may further modify the ownership voucher 104 by adding a customer onboarding service key. The ownership voucher 104 is transferred to a customer onboarding service 108 that is part of a control plane 109. The customer onboarding service 108 authenticates the ownership voucher 104 using a customer onboarding service key and holds the ownership voucher 104 until edge device 102 initiates onboarding.

The edge device 102 travels separately from the ownership voucher 104 and is shipped from the factory 101 to a customer location 110 where device 102 goes through Power ON and onboarding sequences. As part of the onboarding workflow, edge device 102 establishes a first network connection 111 with a rendezvous server 112. Device 102 provides the device identifier (GUID) to rendezvous server 112 and receives from the rendezvous server 112 a network address of the onboarding service 108 on the control plane 109. Upon receipt of the ownership voucher 104, customer onboarding service 108 registers with rendezvous server 112 as an owner of edge device 102.

Device 102 then establishes a second network connection 113 directly with the customer onboarding service 109 utilizing the network address received from the rendezvous server 112. Device 102 receives an ownership voucher 104 from customer onboarding service 108 comprising a chain of trust associated with edge device 102. The chain of trust in the ownership voucher 104 may comprise a sequence of digital signatures signed by different entities in a supply chain between a manufacturer of device 102 and the final customer/owner of device 102. Device 102 updates a non-volatile memory to indicate successful onboarding in responsive to verifying the chain of trust in the ownership voucher 104.

Edge orchestrators, such as NativeEdge from Dell Inc., use FDO to allow explicit edge devices to be built and later onboarded to a customer. This implies that the edge device is built as an appliance (i.e. a system is built with software for a particular edge orchestrator). After the device is received by a customer, FDO can be used to bind that edge device or endpoint to its customer's edge orchestrator control plane using an FDO client included on the edge device by the manufacturer. Since the device is built as an appliance, this means that particular edge orchestrator software is installed in the device at the factory and, therefore, the device must also be ordered as a system compatible with that particular edge orchestrator. Thus, when installed, a particular edge orchestrator interface and its own operating system are installed on the device's main boot disk for execution on the device's main CPU.

Out-of-Band FDO: Separate from the late binding described above, additional efforts have been taken to use the concept of FDO to initialize out-of-band management. Rather than running in-band code to onboard an edge device to an edge orchestrator's control plane at first boot, an out-of-band management system allows onboarding of the device to the control plane at any time. This also means that if an out-of-band management system supports bare metal imaging of the system, then the control plane would be able to deploy or redeploy any operating system to the device at any time. The out-of-band management system would also be able to perform any other hardware-based control (e.g., power, reset, configuration). As used herein the term “bare metal” refers to running software (such as an operating system) directly on a platform's main CPU as opposed to running the software indirectly, such as through a hypervisor, container, or other virtualization system.

Out-of-band FDO may be accomplished several ways. For example, an FDO client may run directly on a Baseboard Management Controller (BMC) on a server or workstation. As used herein, the term BMC refers to a small computer embedded within a larger primary computer and used to allow remote operation, control, and management. Examples of BMC devices include the Integrated Dell Remote Access Controller (iDRAC) from Dell Inc., Integrated Lights-Out (iLO) server management technology from Hewlett Packard Enterprise, and the Cisco Integrated Management Controller (CIMC) from Cisco Systems, Inc.

In other embodiments, the FDO client may run in BIOS or via a protected area of in-band media (i.e., at first boot) to initialize Intel Active Management Technology (AMT) (i.e., OOB capabilities enabled in some Intel chipsets) or similar technology that allows administrators to remotely manage and support networked devices. It will be understood that many out-of-band systems apply broadly and that the present invention is not limited to the mechanisms described herein (e.g., other management applications in addition to iDRAC, iLO, CIMC, AMT may be used).

This means that through a combination of FDO, out-of-band management, and bare metal imaging, a device can automatically and securely boot for the first time, connect to an appropriate management-plane, have any operating system installed, then be able to boot and run the operating system while continued to be fully managed by the control plane through out-of-band, independent of the software/operation system installed.

Out-of-Band Attachment. When generic computers or servers (i.e., white-box systems) are built, sold, and delivered to customers, these devices may be equipped with some sort of inherent management capability (e.g., iDRAC or AMT). Often this management capability is never used because there is no need to connect the device to a control plane. Other times, the management capability may be used directly (e.g., when a user logs into iDRAC), and sometimes the capabilities are specifically connected to control planes, which use these capabilities to manage it. In some cases, the management capabilities come with the purchase of a system, and in other cases they require special licensing. In these situations, the use of such management capability is decided after the device arrives and is set-up. This is referred to as “attachment.” That is, the customer has selected to use or “attach to” an optional capability of the device that was provided, but is used only selectively after the purchase. For example, a large number of consumer and commercial customer systems inherently have an AMT capability, but these devices have a very low attach rate since few users actually use this capability.

In current managed devices, FDO defines how to “zero-touch onboard” a device at first boot and to connect to a control plane to manage the device. FDO devices, such as NativeEdge endpoints, are ordered and built to run FDO client software (in-band) as managed by a late-bound FDO Control Plane. The FDO capabilities can be migrated from in-band planes to our out-of-band management systems for easy first-time setup. Out-of-band management, and its ability to do bare metal imaging, allows control planes to install any operating system on a device. Devices that are shipped with out-of-band capabilities often do so by “attachment” (i.e., opting into and enabling such services after delivery.) Control planes that can manage devices out-of-band do so independent of what operating system or software the device is running. Control planes managing devices out-of-band may also deploy new or different operating systems on the devices.

Devices that depend on in-band connectivity to their control planes require custom manufacturing (e.g., inclusion of an FDO client) and, therefore, custom ordering. If these devices are onboarded via the FDO process (i.e., using FDO code on the device), it means that if this device is subsequently re-imaged during the onboarding process, such as to run some arbitrary Windows build, then FDO will not only be complete after imaging, but the code to execute FDO would neither exist nor run after the initial onboarding.

One business model requires devices to be custom manufactured for their intended control plane. These devices must be explicitly ordered so that they contain the pieces required to connect to, be onboarded to, and managed (and even imaged) by that control plane. This model works with FDO because it allows for custom on-box code at first boot; however, this model has the problem that it must be opted-in during the ordering and manufacturing process.

Another business model involves the ability to ship very generic devices and to allow users to subsequently opt-into (or “attach”) management to these devices after-the-fact by some to-be-determined control plane (e.g., an “AMT model”). This model later suffers from an inability to do this in any kind of onboarding to the control plane in a zero-touch, secure manner. FDO runs at first boot and is complete after initial onboarding. However, devices in the generic system model would be onboarded well after first boot. This means that if a user subsequently decided to place the generic device under management, then the process would have to be completed manually and it would lack the secure aspects of FDO. The manual setup is not desired due to historically low attach rates on things such as AMT, which are observed to be under 10%. The security of late onboarding devices is not desirable because it requires giving a user or onboarding code access to the device to set up as opposed to using a proven model with the ability to do onboarding, such as a manufacturer-installed FDO client.

The embodiments disclosed herein provide the ability to ship “generic” devices or white-box systems that may be subsequently attached to control planes in a zero touch, secure manner such as provided with FDO. These devices may be attached to control planes even if they are already be set-up, imaged, and running in the field. The base technology is a combination of running an FDO process on an out-of-band management plane, such as in a BMC. Following FDO requirements, this means that on initial onboarding FDO would run on the BMC, thereby allowing the device to attempt to onboard to a management plane. When the device does onboard, the management plane takes control to set-up, image, etc.

In normal cases, the FDO process runs at first power-on and onboarding yields control of the device to a management service. This implies that onboarding is required at first boot to credential the control plane. It also implies that if that control plane were to re-image the device, and the FDO onboarding code was run by this same in-band system, which was overwritten in the re-image, then re-onboarding would not be possible. However, these factors are not an issue the system disclosed herein.

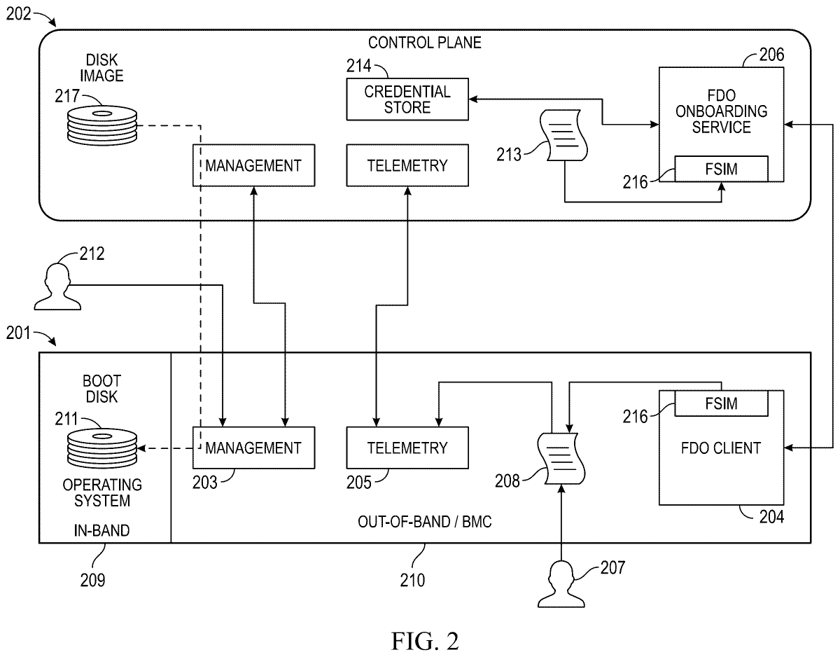

FIG. 2 is a high level block diagram illustrating a generic device or white-box system 201 connected to a control plane 202. In device 201, the management service 203, FDO client 204, and telemetry 205 all run in parallel and may do so perpetually until connected to an FDO onboarding service 206. Device 201 does not need to be connected to, or operated by, a management plane upon initial installation. Instead, a user 207 may install, set-up, and image device 201 manually and bring it into full service. The user 207 may manually provide information 208 comprising management and telemetry configurations, user credentials, and component verification keys. Device 201 may be manually configured and credentialled to communicate with control plane 202, such as, for example, by setting up Redfish credentials so that a management plane could take control and image an in-band system 209 via an out-of-band component or BMC 210.

Since the FDO client 204 is running as a “parallel and perpetual” process, FDO onboarding could take place at any point in time. It will be understood that the term “perpetual” as used herein is intended to mean retrying to connect to an FDO onboarding service 206 until such a connection is made or until manually instructed to stop such attempts. These attempts may run continuously or may occur intermittently at predefined intervals or in response to certain events. The out-of-band component 209 of device 201 will continue to attempt to connect to the FDO onboarding service 206 even if device 201 has been re-imaged to run a particular workload.

Device 201 is configured to expect attachment after-the-fact, which allows an operating system 211 may be installed, imaged, and operated without requiring previous FDO onboarding to control plane 202. Also, because the FDO client 204 is running in out-of-band plane 210, re-imaging the operating system 211 on in-band system 209 would not impede execution of the FDO client 204. Until device 201 is connect to control plane 202, a network administrator 212 can manage device 201 by directly accessing management system 203 in the out-of-band component 210.

The owner of device 201 may later decide to connect the device to control plane 202. The owner can provide an ownership voucher 213 to FDO onboarding service 206. A credential store 214 on control plane 202 may also store configuration and credential details. FDO client 204, which has been perpetually attempting to connect to control plane 202, will now be recognized by FDO onboarding service 206. FDO client 204 will establish a connection 215 to FDO onboarding service 206, which will allow FDO onboarding service 206 to configure device 201 and attach device 201 to control plane 202. FDO Service Info Modules (FSIM) 216 permit the control plane 202 to configure credentials into device 201 with cryptographic privacy and security. As part of the configuration, FDO onboarding service 206 may re-image the operating system 211 on device 201 using an update image 216. Once onboarded, control plane 202 takes over device 201

FIG. 2 is intended to be a general example of out-of-band attachment. It will be understood that there is no specific sequence to how any of the flows or connections occur. The out-of-band configuration may be applied or reapplied at any time, such as automatically via FDO client 204, manually by a user 207, or by system defaults if no other configuration is applied. The in-band system 209 may be imaged/re-imaged at any time either by a user 207 (in-band) or by a control plane 202 (out-of-band). The FDO client run “perpetually,” and it may fail countless times (e.g., due to lacking a connection, no valid ownership voucher, unconfigured, etc.). However, when zero-touch out-of-band capabilities are ultimately decided upon and made available, the FDO client 204 would then suddenly work and connect to FDO onboarding service 206. In the meantime, the software or process running on in-band component 209 have no impact on out-of-band capabilities, credentials, etc. In some configurations, the FDO client 204 may conceivably continue to run even after initial onboarding.

Referring again to FIG. 1, the factory 101 may also manufacture generic devices or white-box systems 114 in addition to endpoint devices 102. The generic devices 114 have their own GUID identifier and their own device keys and credentials 115. A generic device 114 may be installed at a customer premises 110, which may or may not also have edge devices 103 installed. The generic device 114 may be, for example, a compute device, a storage appliance, or a network appliance. Generic device 114 is powered-on and configured at location 110 without connection to a management system or to control plane 109. An FDO client is installed on generic device 114 either at factory 101 or by a later owner. The FDO client begins polling rendezvous server 112 to attempt connection to a control plane. The polling may occur continuously, at intervals, and/or in response to certain events.

Initially, if no control plane has an ownership voucher for generic device 114, then rendezvous server will not have information to connect the FDO client to an onboarding service. Device 114 will begin operating as configured and, in the meantime, the FDO client on device 114 will continue attempting to attach to a control plane. Eventually, if the owner wants to manage generic device 114 via control plane 202, the owner will provide an ownership voucher 116 to customer onboarding service 108. The ownership voucher 116 has the appropriate certificates and keys to authenticate generic device 114.

Customer onboarding service 108 will register generic device 114 with rendezvous server 112. The next time the FDO client polls rendezvous server 112, device 114 will be given the network address of customer onboarding service 108. Device 114 will then establish a network connection 118 directly with the customer onboarding service 108 and will be onboarded to the control plane 109.

In another configuration, an FDO client may be installed on generic device 114 but is turned off by the owner or at the factory. This would allow a later owner to turn on the FDO client so that it could later be enrolled with the control plane and management service.

The embodiments disclosed herein provide a method for shipping generic, white-box systems that are not initially attached to a management system. Instead, the generic, white-box systems are later attached to a control plane in a zero touch, secure manner using, for example, an FDO process. Accordingly, even though a generic, white-box system is already set-up, imaged, and running on a network, it can still exercise a zero-touch, secure late attach option. This allow non-purpose-built equipment (i.e., devices that are not specifically an endpoint system) to be brought under management if desired. Also, this gives manufacturers an additional revenue stream by selling management “after the fact” and for bring systems that were already sold under management. As a result, customers would have the flexibility to buy hardware without committing to a specific management service at time of sale, which gives customers the option to later select a control plane.

Manufacturers also then have the ability to offer newer management services over time and to manufacture “generic” devices that may, or may not be intended for management, which simplifies manufacturing. The manufacturer would also have the ability to update out-of-band firmware to bring control plane compatibility to existing and older devices.

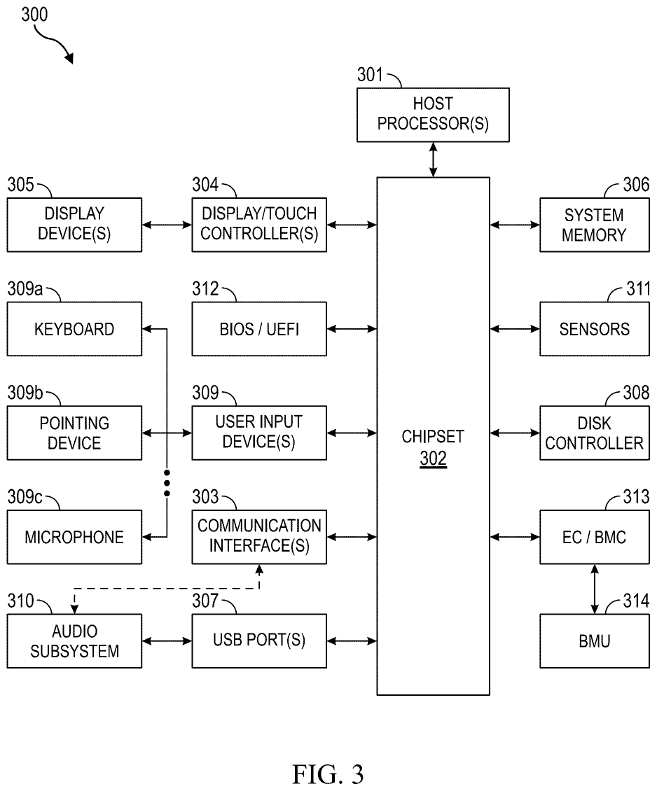

FIG. 3 shows an example of an Information Handling System (IHS) 300 configured to implement systems and methods as described herein for white-box systems and delayed onboarding for late attachment of management systems. IHS 300 may be used as an edge device 102, generic device 114 or 201, or may host a customer onboarding service 108, rendezvous service 112, or control plane 109 or 202.

As depicted, IHS 300 includes host processor(s) 301. In various embodiments, IHS 300 may be a single-processor system, or a multi-processor system including two or more processors. Host processor(s) 301 may include any processor capable of executing program instructions, such as an INTEL/AMD x76 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 300 includes chipset 302 coupled to host processor(s) 301. Chipset 302 may provide host processor(s) 301 with access to resources. In some cases, chipset 302 may utilize a QuickPath Interconnect (QPI) bus to communicate with host processor(s) 301. Chipset 302 may also be coupled to communication interface(s) 303 to enable communications between IHS 300 and various wired and/or wireless networks, such as Ethernet, WiFi (IEEE 802.11), Bluetooth (IEEE 802.15.1), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 303 may be used to communicate with peripheral devices (e.g., Bluetooth speakers, microphones, headsets, etc.). Moreover, communication interface(s) 303 may be coupled to chipset 302 via a Peripheral Component Interconnect Express (PCIe) bus, or the like.

Chipset 302 may be coupled to display and/or touchscreen controller(s) 304, which may include one or more Graphics Processor Units (GPUs) on a graphics bus, such as an Accelerated Graphics Port (AGP) or PCIe bus. As shown, display controller(s) 304 provide video or display signals to one or more display device(s) 305. Display device(s) 305 may include Liquid Crystal Display (LCD), Light Emitting Diode (LED), Organic LED (OLED), or other thin film display technologies. Display device(s) 305 may include a plurality of pixels arranged in a matrix, configured to display visual information, such as text, two-dimensional images, video, three-dimensional images, etc. In some cases, display device(s) 305 may be provided as a single continuous display, rather than two discrete displays.

Chipset 302 may provide host processor(s) 301 and/or display controller(s) 304 with access to system memory 306. In various embodiments, system memory 306 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 302 may also provide host processor(s) 301 with access to one or more Universal Serial Bus (USB) ports/controllers 307, to which one or more peripheral devices may be coupled (e.g., integrated or external webcams, microphones, speakers, etc.).

Chipset 302 may further provide host processor(s) 301 with access to a disk controller 308, which may include a disk interface that connects the disc controller 308 to a Hard Disk Drive (HDD), an Optical Disk Drive (ODD), an SSD, and/or a disk emulator. The disk interface may include, for example, an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. The disk emulator may be provide an external interface that permits one or more hard disk drives, solid-state drives, optical drives, or other removable-media drives to be connected to IHS 300. An example of external interface includes a USB interface, an IEEE 1394 (Firewire) interface, a proprietary interface, or a combination thereof.

Chipset 302 may also provide access to one or more user input devices 309, for example, using a super I/O controller or the like. Examples of user input devices 309 include, but are not limited to, a keyboard 309a, pointing device 309b, such as a mouse, trackball, stylus, or active pen, and/or microphone(s) 309c. Other user input devices 309 (not shown) may include a camera, touchpad, totem, etc. Each user input device 309 may include a respective controller (e.g., a touchpad may have its own touchpad controller) that interfaces with chipset 302 through a wired or wireless connection, for example via communication interfaces(s) 303 and/or USB port(s) 307. Other input devices, such as keyboard 309a, may use a keyboard controller in an operating system.

In some cases, chipset 302 may also provide access to one or more output devices, such as an audio subsystem 310, speakers, headsets, video projectors, paper printers, 3D printers, Virtual/Augmented Reality (VR/AR) devices, etc. The output devices may be accessed, for example, via communication interfaces(s) 303 and/or USB port(s) 307. Audio subsystem 310 may include speakers, which comprise any system, device, or apparatus configured to produce sound in response to electrical audio signal input. In some embodiments, a speaker may comprise a dynamic loudspeaker, which employs a lightweight diaphragm mechanically coupled to a rigid frame via a flexible suspension that constrains a voice coil to move axially through a cylindrical magnetic gap such that when an electrical signal is applied to the voice coil, a magnetic field is created by the electric current in the voice coil, making it a variable electromagnet. The coil and the driver's magnetic system interact, generating a mechanical force that causes the coil (and thus, the attached cone) to move back and forth, thereby reproducing sound under the control of the applied electrical signal coming from the amplifier.

In certain embodiments, chipset 302 may further provide an interface for communications with one or more hardware sensors 311. Sensors 311 may be disposed on or within the chassis of IHS 300, or otherwise coupled to IHS 300, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

A Basic Input and Output System/Unified Extensible Firmware Interface (BIOS/UEFI) 312 is coupled to chipset 302. UEFI was designed as a successor to BIOS, and many modern IHSs utilize UEFI in addition to or instead of a BIOS. Accordingly, BIOS/UEFI 312 is intended to also encompass a UEFI component. BIOS/UEFI 312 provides an abstraction layer that allows the OS to interface with certain hardware components that are utilized by IHS 300. Upon booting of IHS 300, host processor(s) 301 may utilize program instructions of BIOS 312 to initialize and test hardware components coupled to IHS 300, and to load a host OS for use by IHS 300. Via the hardware abstraction layer provided by BIOS/UEFI 312, software stored in system memory 306 and executed by host processor(s) 301 can interface with I/O devices coupled to IHS 300.

An Embedded Controller (EC) 313 (sometimes referred to as a Baseboard Management Controller or “BMC”) includes a microcontroller unit or processing core dedicated to handling selected IHS operations not ordinarily handled by host processor(s) 301. Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes (LEDs) (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 300, EC 313 may be made operational from the very start of each power reset, before other devices are fully running or powered on. As such, EC 313 may be responsible for interfacing with a power adapter to manage the power consumption of IHS 300. These operations may be utilized to determine the power status of IHS 300, such as whether IHS 300 is operating from battery power or is plugged into an AC power source. Firmware instructions utilized by EC 313 may be used to manage other core operations of IHS 300 (e.g., turbo modes, maximum operating clock frequencies of certain components, etc.).

In some cases, EC 313 may implement operations for detecting certain changes to the physical configuration or posture of IHS 300 and managing other devices in different configurations of IHS 300. For instance, when IHS 300 as a 2-in-1 laptop/tablet form factor, EC 313 may receive inputs from a lid position or hinge angle sensor 311, and it may use those inputs to determine: whether the two sides of IHS 300 have been latched together to a closed position or a tablet position, the magnitude of a hinge or lid angle, etc. In response to these changes, the EC may enable or disable certain features of IHS 300 (e.g., front or rear facing camera, etc.).

In some implementations, EC 313 may be installed as a Trusted Execution Environment (TEE) component to the motherboard of IHS 300. Additionally, or alternatively, EC 313 may be further configured to calculate hashes or signatures that uniquely identify individual components of IHS 300. In such scenarios, EC 313 may calculate a hash value based on the configuration of a hardware and/or software component coupled to IHS 300. For instance, EC 313 may calculate a hash value based on all firmware and other code or settings stored in an onboard memory of a hardware component.

In addition, EC 313 may provide an Out-of-Band communication channel that allows an Information Technology Decision Maker (ITDM) or Original Equipment Manufacturer (OEM) to manage IHS 300's various settings and configurations, for example, by issuing OOB commands.

In various embodiments, IHS 300 may be coupled to an external power source through an AC adapter, power brick, or the like. The AC adapter may be removably coupled to a battery charge controller to provide IHS 300 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 314 may be coupled to EC 313 and it may include, for example, an Analog Front End (AFE), storage (e.g., non-volatile memory), and a microcontroller. In some cases, BMU 314 may be configured to collect and store information, and to provide that information to other IHS components.

Examples of information collectible by BMU 314 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc. Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 300 may not include all the components shown in FIG. 3. Furthermore, some components that are represented as separate components in FIG. 3 may instead be integrated with other components, such that all or a portion of the operations executed by the illustrated components may instead be executed by the integrated component. For example, in various embodiments described herein, host processor(s) 301 and/or other components shown in FIG. 3 (e.g., chipset 302, display controller(s) 304, communication interface(s) 303, EC 313, etc.) may be replaced by other devices. As such, IHS 300 may assume different form factors including, but not limited to: servers, workstations, desktops, laptops, appliances, video game consoles, tablet computers, smartphones, etc.

As used herein the term “control plane” refers to a computer, cloud, or system that runs software to help users or administrators manage their endpoint devices.

As used herein the terms “edge device” or “endpoint” refer to a computer or system purchased by a customer or user for the purpose of running their own intended workloads.

As used herein the term “in-band” refers to a computer's main CPU (i.e., the opposite of “out-of-band”).

As used herein the term “late binding” refers to the practice of manufacturing systems without any specific knowledge (or configuration) as to their final end user/customer. Instead, the devices leverage systems such as FDO, which allows the final user to be determined after-the-fact (i.e. in-field).

As used herein the term “out-of-band” refers to executing on a small, sideband management processor of a BMC, which is a separate, small computer with fixed software shipped on it and used only for basic management of the main (in-band) computing platform.

As used herein the term “owner” refers to the end-user, organization, or customer to whom an endpoint device was sold and will operate the endpoint device.

In an example configuration, a device comprises an in-band processor, and a memory having program instructions stored thereon that, upon execution, cause the in-band processor to: execute an operating system; and execute one or more applications without requiring a connection to a management plane. The device further comprises an out-of-band processor, and the memory further having program instructions stored thereon that, upon execution, cause the out-of-band processor to: manage the in-band processor; and execute an onboarding client in parallel with the one or more applications, the onboarding client configured to make repeated attempts to contact an onboarding service. The instructions for the in-band processor and the instructions for the out-of-band processor may be stored on the same or on different memory or storage devices.

The out-of-band processor may be a baseboard management controller (BMC).

The onboarding client may be further configured to query a rendezvous server to identify the onboarding service.

The onboarding client may be configured to query the rendezvous server continuously, at predefined intervals, or in response to certain events. The onboarding client may be configured to execute a zero-touch, secure onboarding process. The zero-touch, secure onboarding process may be a Fast IDentity Online (FIDO) Device Onboarding (FDO) process.

The program instructions may further cause the out-of-band processor to establish a connection to the onboarding service, and to attach the device to a control plane. The program instructions may further cause the out-of-band processor to continue to execute the onboarding client after the device is attached to the control plane. The onboarding client may be configured to identify changes in device ownership or device configuration after the device is attached to the control plane.

The out-of-band processor may begin execution of the onboarding client only when instructed by a user. In this case, the out-of-band processor may wait for the user to initiate the onboarding process. Alternatively, the out-of-band processor may attempt the onboarding process for a period of time and then stop until the process is started again under user command.

An example method for attaching a device to a control plane comprises configuring operation of an in-band system during an initial power-on without requiring attachment to a control plane; executing operation of the in-band system; and executing an onboarding process on an out-of-band component in parallel with and independently of the operation of the in-band system, wherein the out-of-band onboarding process perpetually attempts to contact a remote onboarding service. The out-of-band component may be a baseboard management controller (BMC). The out-of-band onboarding process may be configured to query a rendezvous server to identify the remote onboarding service. The out-of-band onboarding process may be configured to query the rendezvous server continuously, at predefined intervals, or in response to certain events. The out-of-band onboarding process may be configured to execute a zero-touch, secure connection to a control plane, such as a Fast IDentity Online (FIDO) Device Onboarding (FDO) process.

The method may further comprise establishing, by the out-of-band processor, a connection to the remote onboarding service; and attaching the device to a control plane using the remote onboarding service.

The may further comprise continuing to execute the out-of-band onboarding process after the device is attached to the control plane. The method may further comprise identifying, by the out-of-band onboarding process, changes in device ownership or device configuration after the device is attached to the control plane.

The method may further comprise beginning execution of the out-of-band onboarding process only when instructed by a user after operation of the in-band system has started.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A device, comprising:
an in-band processor;
a memory having program instructions stored thereon that, upon execution, cause the in-band processor to:
execute an operating system; and
execute one or more applications without requiring a connection to a management plane;
an out-of-band processor;
the memory further having program instructions stored thereon that, upon execution, cause the out-of-band processor to:
manage the in-band processor;
execute an onboarding client in parallel with the one or more applications, the onboarding client configured to make repeated attempts to contact an onboarding service.

2. The device of claim 1, wherein the out-of-band processor is a baseboard management controller (BMC).

3. The device of claim 1, wherein the onboarding client is further configured to query a rendezvous server to identify the onboarding service.

4. The device of claim 1, wherein the onboarding client is configured to query the rendezvous server continuously, at predefined intervals, or in response to certain events.

5. The device of claim 1, wherein the onboarding client is configured to execute a zero-touch, secure onboarding process.

6. The device of claim 5, wherein the zero-touch, secure onboarding process is a Fast IDentity Online (FIDO) Device Onboarding (FDO) process.

7. The device of claim 1, wherein the program instructions further cause the out-of-band processor to establish a connection to the onboarding service, and to attach the device to a control plane.

8. The device of claim 7, wherein the program instructions further cause the out-of-band processor to continue to execute the onboarding client after the device is attached to the control plane.

9. The device of claim 8, wherein the onboarding client is configured to identify changes in device ownership or device configuration after the device is attached to the control plane.

10. The device of claim 1, wherein the out-of-band processor begins execution of the onboarding client only when instructed by a user.

11. A method for attaching a device to a control plane, comprising:
configuring operation of an in-band system during an initial power-on without requiring attachment to a control plane;
executing operation of the in-band system; and
executing an onboarding process on an out-of-band component in parallel with and independently of the operation of the in-band system, wherein the out-of-band onboarding process perpetually attempts to contact a remote onboarding service.

12. The method of claim 11, wherein the out-of-band component is a baseboard management controller (BMC).

13. The method of claim 11, wherein the out-of-band onboarding process is configured to query a rendezvous server to identify the remote onboarding service.

14. The method of claim 11, wherein the out-of-band onboarding process is configured to query the rendezvous server continuously, at predefined intervals, or in response to certain events.

15. The method of claim 11, wherein the out-of-band onboarding process is configured to execute a zero-touch, secure connection to a control plane.

16. The method of claim 15, wherein the zero-touch, secure onboarding process is a Fast IDentity Online (FIDO) Device Onboarding (FDO) process.

17. The method of claim 11, further comprising:
establishing, by the out-of-band processor, a connection to the remote onboarding service; and
attaching the device to a control plane using the remote onboarding service.

18. The method of claim 17, further comprising:
continuing to execute the out-of-band onboarding process after the device is attached to the control plane.

19. The method of claim 18, further comprising:
identifying, by the out-of-band onboarding process, changes in device ownership or device configuration after the device is attached to the control plane.

20. The method of claim 11, further comprising:
beginning execution of the out-of-band onboarding process only when instructed by a user after operation of the in-band system has started.
